(19) United States
(12) Patent Application Publication
(10) Pub. No.: US 2025/0033370 A1
(43) Pub. Date: Jan. 30, 2025

(54) INKJET PRINTER

(71) Applicant: Samsung Display Co., LTD., Yongin-si (KR)

(72) Inventor: EUNSEOK KIM, Yongin-si (KR)

(21) Appl. No.: 18/626,177

(22) Filed: Apr. 3, 2024

(30) Foreign Application Priority Data
Jul. 24, 2023 (KR) 10-2023-0095847

(51) Int. Cl. B41J 2/175; B41J 2/045; B41J 3/407

(52) U.S. Cl. CPC B41J 2/17596; B41J 2/04563; B41J 3/407

(57) ABSTRACT

An inkjet printer includes an ink ejection module including head packs including heads that eject an ink, an ink storage module that stores the ink, and modules that receive the ink from the ink storage module and deliver the ink to each of the head packs. Each of the modules includes a body having a structure that is interconnectable in a first direction and including first and second surfaces facing each other in the first direction, pipes penetrating the body in the first direction and separated from each other in a second direction crossing the first direction, a first supply flow path and a first recovery flow path disposed between at least one of the pipes and the ink ejection module and separated from each other, and a flow controller connected to the first supply flow path between a pipe of the pipes and the ink ejection module.

This application claims priority to Korean Patent Application No. 10-2023-0095847, filed on application Revision Jul. 24, 2023, and all the benefits accruing therefrom under 35 U.S.C. § 119, the content of which in its entirety is herein incorporated by reference.

### BACKGROUND

### 1. Field

The disclosure relates to an inkjet printer. More specifically, the disclosure relates to an inkjet printer for manufacturing a display device.

### 2. Description of the Related Art

A display device may be manufactured by various processes. For example, a light-emitting layer included in the display device may be formed by an inkjet process. The light-emitting layer may be formed by ejecting ink including a light-emitting material onto a substrate. The ink may be ejected onto the substrate by the inkjet printer. The inkjet printer may include a plurality of heads. The plurality of heads may be assembled into one head pack.

### SUMMARY

As the display device becomes larger, a size of the inkjet printer also becomes larger. As the size of the inkjet printer becomes larger, the number of head packs also increases.

Embodiments provide circular inkjet printer.

Embodiments provide non-circular inkjet printer.

An inkjet printer in an embodiment includes an ink ejection module including a plurality of head packs including a plurality of heads that eject an ink, an ink storage module that stores the ink, and a plurality of modules that receive the ink from the ink storage module and deliver the ink to each of the plurality of head packs. Each of the plurality of modules includes a body having a structure that is interconnectable in a first direction and including a first surface and a second surface that faces the first surface in the first direction, a plurality of pipes penetrating the body in the first direction and separated from each other in a second direction crossing the first direction; a first supply flow path and a first recovery flow path disposed between at least one of the plurality of pipes and the ink ejection module and separated from each other; and a flow controller connected to the first supply flow path between a pipe of the plurality of pipes and the ink ejection module.

In an embodiment, the inkjet printer may further include a connection block. The plurality of modules may include a first module that receives the ink from the ink storage module, to an (n)th module (where the n is a natural number of 2 or more) spaced farthest from the first module in the first direction. The first surface of the body of the (n)th module may contact the (n−1)th module, and the second surface of the body of the (n)th module may contact the connection block.

In an embodiment, the plurality of pipes may include a first pipe, a second pipe connected to the first recovery flow path, a third pipe connected to the first supply flow path, and a fourth pipe. The connection block may include a first connection pipe connecting the first pipe and the second pipe, and a second connection pipe connecting the third pipe and the fourth pipe.

In an embodiment, the first pipe of the first module may include a first end, and a second end spaced apart from the first end in the first direction. The first end may be connected to the ink storage module, and the second end may be connected to the first pipe of the second module. The first pipe of the (n)th module may include a third end, and a fourth end spaced apart from the third end in the first direction, the third end may be connected to the first end of the (n−1)th module, and the fourth end may be connected to the first connection pipe. The fourth pipe of the first module may include a fifth end, and a sixth end spaced apart from the fifth end in the first direction, the fifth end may be connected to the ink storage module, and the sixth end may be connected to the fourth pipe of the second module. And, the fourth pipe of the (n)th module may include a seventh end, and an eighth end spaced apart from the seventh end in the first direction, the seventh end may be connected to the fourth pipe of the (n−1)th module, and the eighth end may be connected to the second connection pipe.

In an embodiment, the inkjet printer may further include a first heater penetrating the body and disposed between the first pipe and the second pipe; and a second heater penetrating the body and disposed between the third pipe and the fourth pipe.

In an embodiment, the inkjet printer may further include a thermometer disposed in the body; and a temperature controller connected to the first heater and the second heater.

In an embodiment, each of the plurality of modules may further include a pressure compensation block disposed on a bottom surface of each of the plurality of modules.

In an embodiment, each of the plurality of modules may further include an alignment pin protruding from the first surface; and an alignment hole defined at a position corresponding to the alignment pin in the second surface. And, the alignment hole may have a degree of freedom in the second direction.

In an embodiment, each of the plurality of modules may further include a sealing member which surrounds each of the plurality of pipes on the second surface.

In an embodiment, the ink storage module may include an ink tank, a first reservoir, and a second reservoir. The ink may flow in a first path supplying from the ink tank to the first reservoir; a second path circulating between the first reservoir and the second reservoir; a third path recovering from the second reservoir to the ink tank; and a fourth path circulating between the plurality of modules and the second reservoir.

An inkjet printer in an embodiment includes an ink ejection module including a plurality of head packs including a plurality of heads that eject an ink; an ink storage module that stores the ink; and a plurality of modules that receive the ink from the ink storage module and deliver the ink to each of the plurality of head packs. Each of the plurality of modules may include a body having a structure that is interconnectable in a first direction and including a first surface and a second surface that faces the first surface in the first direction; a plurality of pipes penetrating the body in the first direction and separate from each other in a second direction crossing the first direction; a first supply flow path and a second supply flow path disposed between at least one of the plurality of pipes and the ink ejection module and separated from each other; and a flow controller connected to each of the first supply flow path and the second supply flow path between the pipe and the ink ejection module.

In an embodiment, the inkjet printer may further include a connection block. The plurality of modules may include a first module that receives the ink from the ink storage module, to an (n)th module (where the n is a natural number of 2 or more) spaced farthest from the first module in the first direction, the first surface of the body of the (n)th module may contact the (n−1)th module, and the second surface of the body of the (n)th module may contact the connection block.

In an embodiment, the plurality of pipes may include a first pipe, a second pipe connected to the second supply flow path, a third pipe connected to the first supply flow path, and a fourth pipe. The connection block may include a first connection pipe connecting the first pipe and the second pipe, and a second connection pipe connecting the third pipe and the fourth pipe.

In an embodiment, the first pipe of the first module may include a first end, and a second end spaced apart from the first end in the first direction. The first end may be connected to the ink storage module, and the second end may be connected to the first pipe of the second module. The first pipe of the (n)th module may include a third end, and a fourth end spaced apart from the third end in the first direction. The third end may be connected to the first end of the (n−1)th module, and the fourth end may be connected to the first connection pipe. The fourth pipe of the first module may include a fifth end, and a sixth end spaced apart from the fifth end in the first direction. The fifth end may be connected to the ink storage module, and the sixth end may be connected to the fourth pipe of the second module. The fourth pipe of the (n)th module may include a seventh end, and an eighth end spaced apart from the seventh end in the first direction. The seventh end may be connected to the fourth pipe of the (n−1)th module, and the eighth end may be connected to the second connection pipe.

In an embodiment, the inkjet printer may further include a first heater penetrating the body and disposed between the first pipe and the second pipe; and a second heater penetrating the body and disposed between the third pipe and the fourth pipe.

In an embodiment, the inkjet printer may further include a thermometer disposed in the body; and a temperature controller connected to the first heater and the second heater.

In an embodiment, ach of the plurality of modules may further include a pressure compensation block disposed on a bottom surface of each of the plurality of modules.

In an embodiment, each of the plurality of modules may further include an alignment pin protruding from the first surface; and an alignment hole defined at a position corresponding to the alignment pin in the second surface. The alignment hole may have a degree of freedom in the second direction.

In an embodiment, each of the plurality of modules may further include a sealing member which surrounds each of the plurality of pipes on the second surface.

In an embodiment, the ink storage module may include an ink tank, a first reservoir, and a second reservoir. The ink may flow in a first path supplying from the ink tank to the first reservoir; a second path circulating between the first reservoir and the second reservoir; a third path recovering from the second reservoir to the ink tank; and a fourth path circulating between the plurality of modules and the second reservoir.

An inkjet printer in embodiments of the disclosure may include an ink ejection module including a plurality of head packs including a plurality of heads that eject an ink; an ink storage module that stores the ink; and a plurality of modules that receive the ink from the ink storage module and deliver the ink to each of the plurality of head packs. Each of the plurality of modules includes a body having a structure that is interconnectable in a first direction and including a first surface and a second surface that faces the first surface in the first direction; a plurality of pipes penetrating the body in the first direction and having a separate structure in a second direction crossing the first direction; a first supply flow path and a first recovery flow path (or a second supply flow path) disposed between at least one of the plurality of pipes and the ink ejection module and having structure separated from each other; and a flow controller connected to the first supply flow path (and/or a second supply flow path) between the pipe and the ink ejection module. Accordingly, the ink delivery module may be easily added or removed in response increases or decreases in the number of the head packs.

In addition, the plurality of modules included in the inkjet printer may further include heaters. Accordingly, the inkjet printer may keep a temperature of the flowing ink along the plurality of modules constant.

In addition, the plurality of modules included in the inkjet printer may further include a pressure compensation block. Accordingly, the inkjet printer may prevent a pressure drop of the flowing ink along the plurality of modules.

In addition, the plurality of modules included in the inkjet printer may further include an alignment pin and an alignment hole. The alignment hole may have a degree of freedom in a second direction. Accordingly, the alignment pin may be accommodated in the alignment hole even when a step occurs in the second direction.

In addition, the plurality of modules included in the inkjet printer may further include a sealing member. Accordingly, the inkjet printer may prevent liquid leakage from connection portions of the plurality of modules.

### BRIEF DESCRIPTION OF THE DRAWINGS

Illustrative, non-limiting embodiments will be more clearly understood from the following detailed description taken in conjunction with the accompanying drawings.

FIG. 1 is a plan view of an embodiment of an inkjet printer according to the disclosure.

FIG. 2 is a block view illustrating an embodiment of the ink supply system included in the inkjet printer of FIG. 1.

FIG. 3 is a block view illustrating the ink storage module included in the ink supply system of FIG. 2.

FIG. 4 is a block view illustrating the circulation control module included in the ink storage module of FIG. 3.

FIG. 5 is a view illustrating a pressure control module included in the ink storage module of FIG. 3.

FIG. 6 is a view illustrating the ink delivery module and ink ejection module included in the ink supply system of FIG. 2.

FIGS. 7 to 14 are views illustrating the ink delivery module assembly included in the ink delivery module of FIG. 6.

FIG. 15 is a block view illustrating an embodiment of the ink supply system included in the inkjet printer of FIG. 1.

FIG. 16 is a block view illustrating the ink storage module included in the ink supply system of FIG. 15.

FIG. 17 is a view illustrating the pressure control module included in the ink storage module of FIG. 16.

FIG. 18 is a view illustrating the ink delivery module and the ink ejection module included in the ink supply system of FIG. 15.

FIGS. 19 to 22 are views illustrating the ink delivery module assembly included in the ink delivery module of FIG. 18.

### DETAILED DESCRIPTION

Embodiments of the disclosure now will be described more fully hereinafter with reference to the accompanying drawings, in which various embodiments are shown. This invention may, however, be embodied in many different forms, and should not be construed as limited to the embodiments set forth herein. Rather, these embodiments are provided so that this disclosure will be thorough and complete, and will fully convey the scope of the invention to those skilled in the art. Like reference numerals refer to like elements throughout.

It will be understood that when an element is referred to as being “on” another element, it can be directly on the other element or intervening elements may be present therebetween. In contrast, when an element is referred to as being “directly on” another element, there are no intervening elements present.

It will be understood that, although the terms “first,” “second,” “third” etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, “a first element,” “component,” “region,” “layer” or “section” discussed below could be termed a second element, component, region, layer or section without departing from the teachings herein.

The terminology used herein is for the purpose of describing particular embodiments only and is not intended to be limiting. As used herein, the singular forms “a,” “an,” and “the” are intended to include the plural forms, including “at least one,” unless the content clearly indicates otherwise. “Or” means “and/or.” As used herein, the term “and/or” includes any and all combinations of one or more of the associated listed items. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Furthermore, relative terms, such as “lower” or “bottom” and “upper” or “top,” may be used herein to describe one element's relationship to another element as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The exemplary term “lower,” can therefore, encompasses both an orientation of “lower” and “upper,” depending on the particular orientation of the figure. Similarly, if the device in one of the figures is turned over, elements described as “below” or “beneath” other elements would then be oriented “above” the other elements. The exemplary terms “below” or “beneath” can, therefore, encompass both an orientation of above and below.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

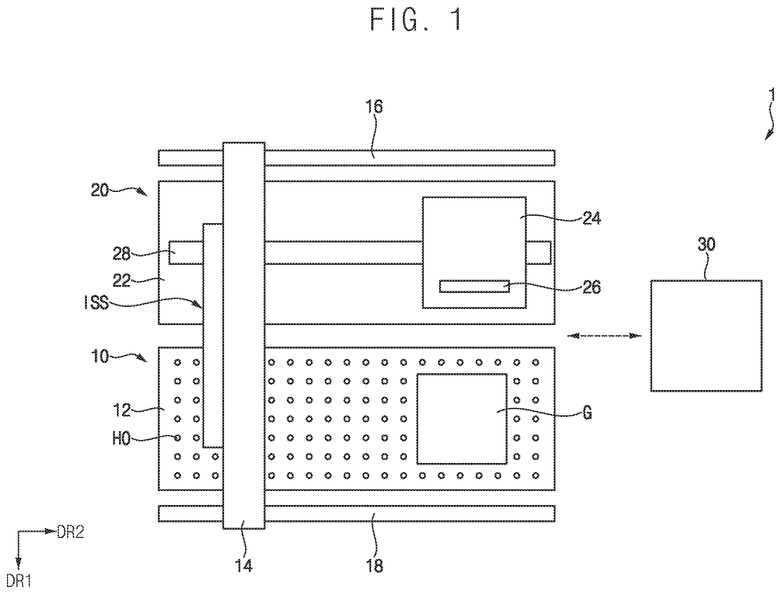

FIG. 1 is a plan view of an embodiment of an inkjet printer according to the disclosure.

Referring to FIG. 1, an inkjet printer 1 in embodiments of the disclosure may include a processor 10, a maintenance device 20, and a controller 30.

The processor 10 may process an inkjet process by ejecting ink onto a substrate G. The processor 10 may include a first stage 12, a gantry 14, an ink supply system ISS, and a first driver.

The substrate G may be disposed on the first stage 12. In an embodiment, an air hole HO may be formed in the first stage 12, for example. In an embodiment, the air hole HO may be connected to a vacuum forming device, for example. The vacuum forming device may supply suction pressure to the air hole HO. Accordingly, the substrate G may be fixed to the first stage 12.

When the substrate G is not fixed, the substrate G may shake during the inkjet process progresses. In this case, the ink may be ejected into an unintended area on the substrate G. Accordingly, defects (e.g., color mixing, dark spots, or the like) may occur in the display device.

The inkjet printer 1 in embodiments may fix the substrate G to the first stage 12 by the suction pressure. Accordingly, the defects in the display device due to the substrate shaking may be prevented.

However, the disclosure is not limited thereto. The vacuum forming device may supply negative pressure to the air hole HO. Accordingly, the substrate G may be levitated on the first stage 12.

The gantry 14 may support the ink supply system ISS. The ink supply system ISS may eject the ink onto the substrate G on the first stage 12. For this purpose, the gantry 14 may be disposed on the first stage 12.

The first driver may guide a movement path of the gantry 14. In an embodiment, the first driver may include a first guide rail 16 and a second guide rail 18, for example. The gantry 14 may slide along the first guide rail 16 and the second guide rail 18. In an embodiment, the first guide rail 16 and the second guide rail 18 may be implemented as a linear motor (“LM”) guide system, for example. However, the disclosure is not limited thereto.

The maintenance device 20 may include a second stage 22, a first plate 24, a calibration board 26, and a second driver. The maintenance device 20 may measure an ink ejection position and whether the ink is ejected on the substrate G, and provide a measurement results to the controller 30.

The ink supply system ISS may be fixed to the gantry 14. However, the disclosure is not limited thereto. In an embodiment, the ink supply system ISS may be movably disposed on the gantry 14, for example. In an embodiment, the ink supply system ISS may be installed to be able to move rotatably on the gantry 14, for example. In another embodiment, the ink supply system ISS may be installed to be able to move linearly on the gantry 14.

The ink supply system ISS may supply the ink. In an embodiment, the ink may be an ink including a quantum dot, for example. However, the disclosure is not limited thereto. The ink may include a variety of materials used in manufacturing the display device.

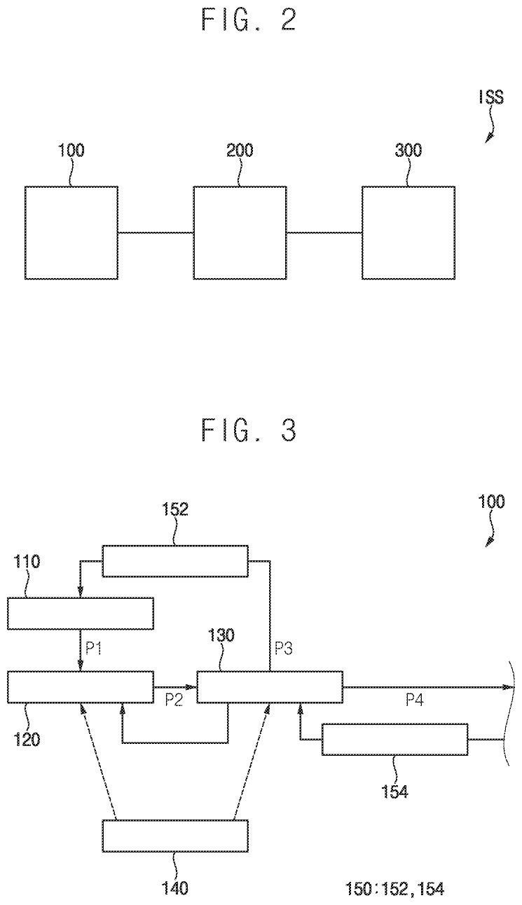

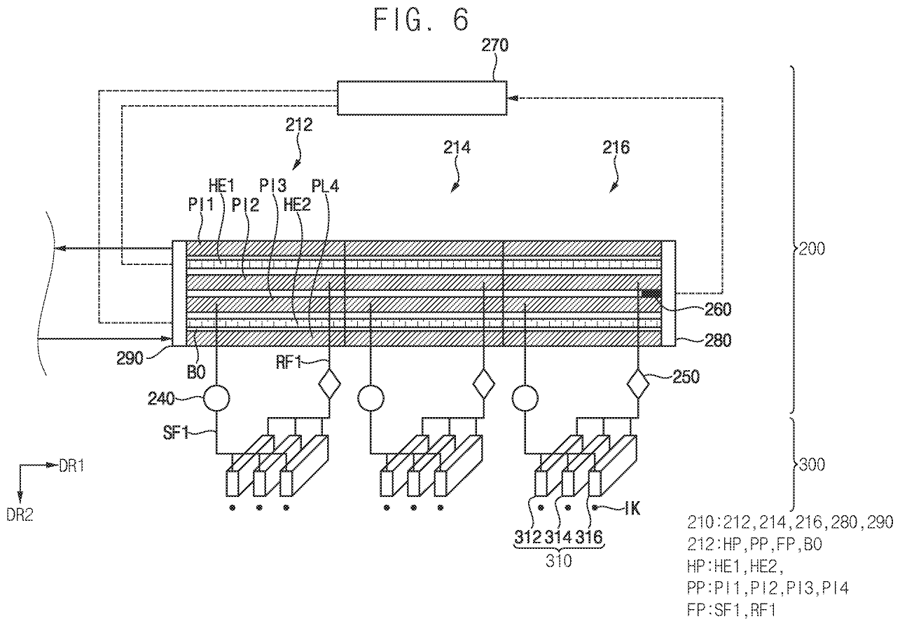

The ink supply system ISS may include a plurality of head packs (e.g., a plurality of head packs 310 of FIG. 6), each of the head packs may include a plurality of heads (e.g., a first head 312, a second head 314, and a third head 316 of FIG. 6). Each of the plurality of heads may include a plurality of nozzles. The plurality of nozzles may be arranged in a matrix with regular intervals. In an embodiment, the plurality of nozzles may adjust ejecting amount according to a voltage applied to a piezoelectric element, for example. A detailed description of the ink supply system ISS will be described later with reference to FIG. 2 and below.

Like the first stage 12, the second stage 22 may be a base on which various components may be disposed (e.g., mounted). In an embodiment, a size of the second stage 22 may be smaller than a size of the first stage 12, for example. However, the disclosure is not limited thereto. In an embodiment, the size of the second stage 22 may be larger than the size of the first stage 12 or may be substantially a same as the size of the first stage 12, for example.

The second driver may guide a movement path of the first plate 24. In an embodiment, the second driver may include a third guide rail 28. The first plate 24 may slide along the third guide rail 28, for example.

However, the disclosure is not limited thereto. In an embodiment, each of the first driver and the second driver may include different components, for example. In an alternative embodiment, the first guide rail 16, the second guide rail 18 and/or the third guide rail 28 may be omitted.

The first plate 24 may be moved on the second stage 22 by the second driver. In an embodiment, the first plate 24 may move parallel to the substrate G by the second driver, for example. However, the disclosure is not limited thereto. In an embodiment, the first plate 24 may be farther away from the substrate G or closer to the substrate G, for example.

The calibration board 26 may measure an ejecting position on the substrate G. In an embodiment, the calibration board 26 may be disposed on first plate 24 and may include an alignment mark, a ruler, or the like, for example.

The controller 30 may maintain the processor 10 and the maintenance device 20. The controller 30 may receive the measurement results from the maintenance device 20 and detect a defective nozzle or adjust the ejecting position. However, the disclosure is not limited thereto. In an embodiment, the controller 30 may perform various control operations, for example.

The controller 30 may include a process controller, a control program, an input module, an output module (or a display module), a memory module, or the like. In an embodiment, the process controller may include a microprocessor, for example. The microprocessor may control the components of the inkjet printer 1. The control program may execute various processes of the inkjet printer 1 under the control of the process controller. The memory module may store a program, that is, a processing recipe, for executing various processes of the inkjet printer 1 according to various data, processing conditions, or the like. In an embodiment, the controller 30 may be implemented as a computer, server, or the like, for example.

The components of the inkjet printer 1 of FIG. 1 are exemplary, and the components may be omitted or other components may be further included. In an embodiment, the inkjet printer 1 may further include a vision module for photographing the substrate G, for example.

FIG. 2 is a block view illustrating an embodiment of the ink supply system included in the inkjet printer of FIG. 1.

Referring to FIG. 2, the ink supply system ISS may include an ink storage module 100, an ink delivery module 200, and an ink ejection module 300.

In an embodiment, the ink storage module 100 may temporarily store the ink. The ink delivery module 200 may receive the ink from the ink storage module 100 and deliver the ink to the ink ejection module 300. The ink ejection module 300 may eject the ink.

A detailed description of each configuration of the ink storage module 100, the ink delivery module 200, and the ink ejection module 300 will be described later with reference to FIG. 3 and below.

FIG. 3 is a block view illustrating the ink storage module included in the ink supply system of FIG. 2.

Referring to FIGS. 2 and 3, in an embodiment, the ink storage module 100 may include an ink tank 110, a first reservoir 120, a second reservoir 130, a pressure control module 140, and a circulation control module 150.

The ink tank 110 may receive the ink from an external ink source and store the ink.

The first reservoir 120 and the second reservoir 130 may receive the ink from the ink tank 110 and store the ink. In an embodiment, the first reservoir 120 may be a supply reservoir, and the second reservoir 130 may be a recovery reservoir for recovering unused ink, for example. However, the disclosure is not limited thereto. In an embodiment, the first reservoir 120 may be the recovery reservoir, and the second reservoir 130 may be the supply reservoir, for example.

The circulation control module 150 may be disposed in a path to recover the unused ink from the ink ejection module 300. The circulation control module 150 may include a first circulation control module 152 and a second circulation control module 154. The first circulation control module 152 may be disposed in a path where the ink is recovered from the second reservoir 130 to the ink tank 110. The second circulation control module 154 may be disposed in a path where the ink is recovered from the ink delivery module 200 to the second reservoir 130.

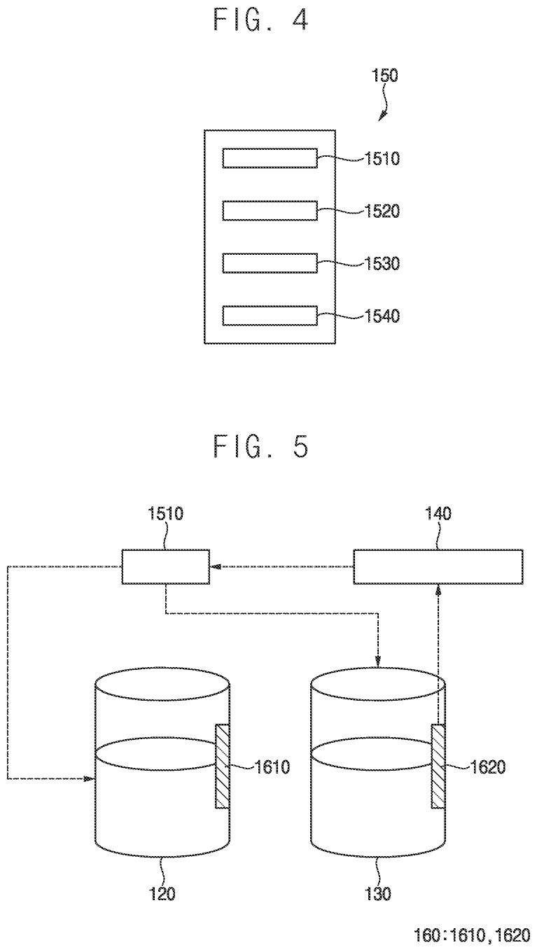

A detailed description of the circulation control module 150 will be described later with reference to FIG. 4.

The pressure control module 140 may control an internal pressure of the ink tank 110. The ink tank 110 may supply a predetermined amount of the ink to the first reservoir 120 based on the pressure provided by the pressure control module 140.

A detailed description of the pressure control module 140 will be described later with reference to FIG. 5.

In an embodiment, the ink may flow in a first path P1, a second path P2, a third path P3, and a fourth path P4. In an embodiment, the first path P1 may be a path supplying ink from the ink tank 110 to the first reservoir 120, for example. The second path P2 may be a path that circulates between the first reservoir 120 and the second reservoir 130. The third path P3 may be a path through which the ink is recovered from the second reservoir 130 to the ink tank 110. The fourth path P4 may be a path that circulates between the second reservoir 130 and the ink delivery module 200.

The circulating ink storage module 100 may prevent precipitation of a particle (e.g., the quantum dot) in the ink and increase a lifespan of the inkjet printer 1.

FIG. 4 is a block view illustrating the circulation control module included in the ink storage module of FIG. 3.

Referring to FIGS. 3 and 4, for example, each of the circulation control module 150 may include a pump 1510, a filter 1520, a gas remover 1530, and a flow meter 1540.

The pump 1510 may provide the pressure so that the ink may flow. The single pump 1510 may be included, or a plurality of pumps 1510 may be included. In order to maintain a water level of the second reservoir 130 constant, the pressure input to the pump 1510 may be varied.

The filter 1520 may filter the recovered ink. A single filter 1520 may be included, or a plurality of filters 1520 may be included.

The gas remover 1530 may remove gas from the recovered ink.

The flow meter 1540 may measure a flow rate of ink. In an embodiment, the flow meter 1540 included in the first circulation control module 152 may measure the flow rate of ink flowing from the second reservoir 130 to the ink tank 110, and the second circulation control, for example. The flow meter 1540 included in the second circulation control module 154 may measure the flow rate of ink flowing from the ink delivery module 200 to the second reservoir 130, for example.

FIG. 5 is a view illustrating a pressure control module included in the ink storage module of FIG. 3.

Referring to FIGS. 3 and 5, the ink storage module 100 may include the first reservoir 120, the second reservoir 130, the pressure control module 140, the pump 1510, and a water level gauge 160.

The pressure control module 140 may control a pressure of the first reservoir 120, a pressure of the second reservoir 130, and a pressure of the pump 1510. In an embodiment, the pressure control module 140 may be implemented as a pressure controller module (“PCM”) including a pressure controller (“PCON”) board, for example. However, the disclosure is not limited thereto.

The pressure control module 140 may independently control the pressure of the first reservoir 120 and the pressure of the second reservoir 130. In an embodiment, the one pressure control module 140 may be connected to the first reservoir 120 and the second reservoir 130, and the pressure of the first reservoir 120 and the pressure of the second reservoir 130 may be controlled independently, for example. However, the disclosure is not limited thereto. In an embodiment, the pressure control module 140 may be provided separately for each of the first reservoir 120 and the second reservoir 130, for example.

The water level gauge 160 may include a first water level gauge 1610 and a second water level gauge 1620. In an embodiment, the first water level gauge 1610 may measure a water level of ink stored in the first reservoir 120, for example. The second water level gauge 1620 may measure a water level of ink stored in the second reservoir 130.

The water level of the second reservoir 130 measured by the second water level gauge 1620 may be transmitted to the pressure control module 140. The pressure control module 140 may flow the ink using the pump 1510 from the first reservoir 120 to the second reservoir 130 (or from the second reservoir 130 to the first reservoir 120).

FIG. 6 is a view illustrating the ink delivery module and ink ejection module included in the ink supply system of FIG. 2.

Referring to FIGS. 2 and 6, in an embodiment, the ink delivery module 200 may include a plurality of modules 210. The plurality of modules 210 may receive ink IK from the ink storage module 100 and deliver the ink IK to the ink ejection module 300.

In an embodiment, the ink ejection module 300 may include the plurality of head packs 310. Each of the plurality of head packs 310 may include the plurality of heads that eject the ink IK. In an embodiment, one of the plurality of head packs 310 may include the first head 312, the second head 314, and the third head 316, for example. Each of the first head 312, the second head 314, and the third head 316 may eject the ink IK.

In an embodiment, the plurality of modules 210 may receive the ink IK from the ink storage module 100 and deliver the ink IK to each of the plurality of head packs 310.

In an embodiment, each of the plurality of modules 210 may include a body BO, a plurality of pipes PP, a flow path portion FP, a heating portion HP, a flow controller 240, and a flow meter 250.

In an embodiment, the body BO may have a structure that may be interconnectable in a first direction DR1. Accordingly, the plurality of modules 210 may be added or removed depending on the number of head packs 310.

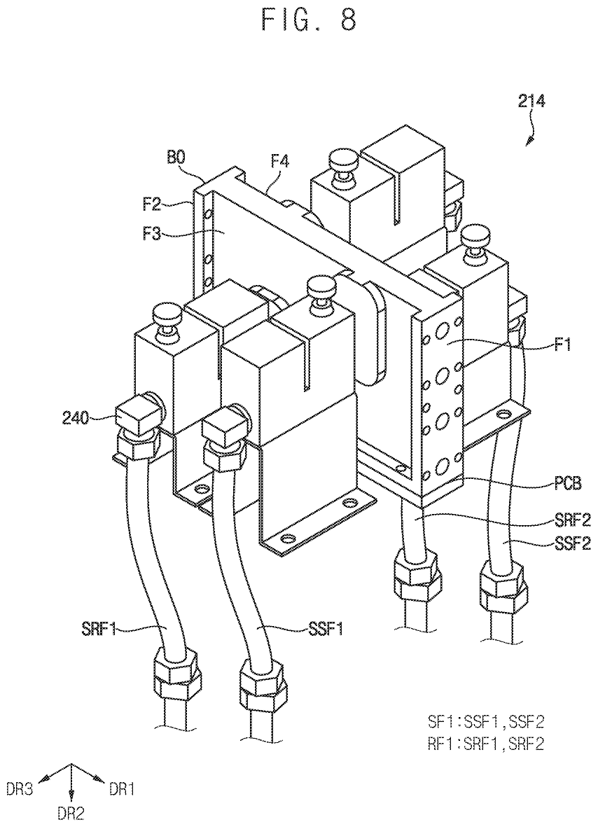

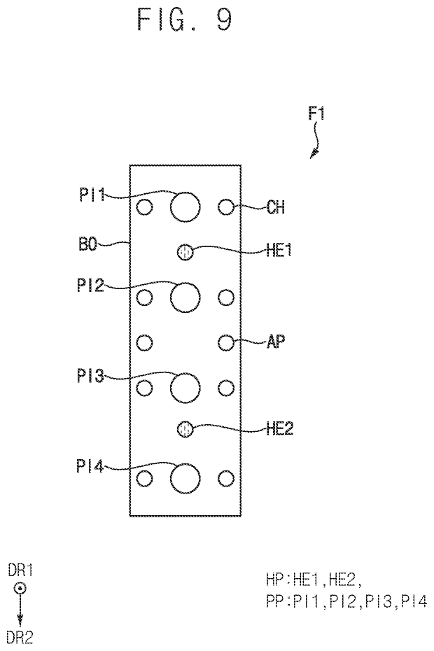

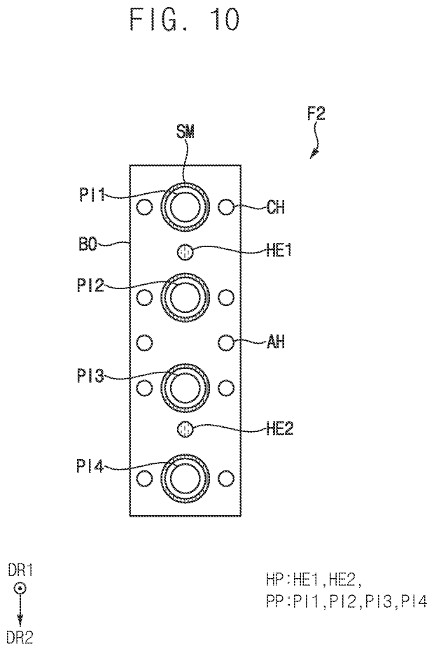

A detailed description of the structure of the body BO will be described later with reference to FIGS. 8 to 13.

In an embodiment, the plurality of pipes PP may have a structure that penetrates the body BO in the first direction DR1 and are separated from each other in a second direction DR2.

In an embodiment, the plurality of pipes PP may include a first pipe PI1, a second pipe PI2, a third pipe PI3, and a fourth pipe PI4. Each of the first pipe PI1, the second pipe PI2, the third pipe PI3, and the fourth pipe PI4 may penetrate the body BO in the first direction DR1 and may be spaced apart from each other in the second direction DR2.

In an embodiment, the flow path portion FP may be disposed between at least one of the plurality of pipes PP and the ink ejection module 300. The flow path portion FP may include a first supply flow path SF1 and a first recovery flow path RF1 having structures separated from each other.

In an embodiment, the second pipe PI2 may be connected to the first recovery flow path RF1, and the third pipe PI3 may be connected to the first supply flow path SF1.

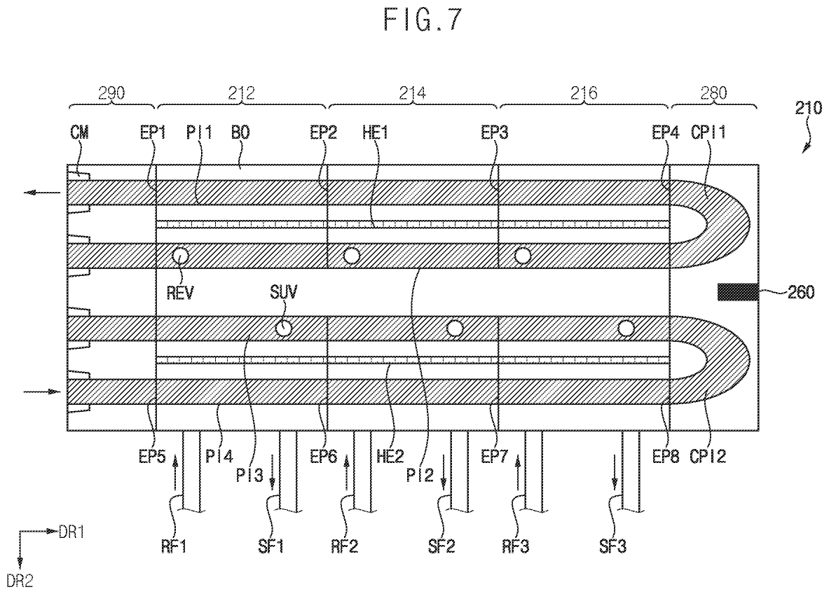

A detailed description of a connection piping system between the plurality of pipes PP and the flow path portion FP will be described later with reference to FIG. 7.

In an embodiment, the heating portion HP may include a first heater HE1 and a second heater HE2. The first heater HE1 may penetrate the body BO and be disposed between the first pipe PI1 and the second pipe PI2. The second heater HE2 may penetrate the body BO and be disposed between the third pipe PI3 and the fourth pipe PI4.

In an embodiment, the flow controller 240 may be connected to the first supply flow path SF1 between at least one of the plurality of pipes PP and the ink ejection module 300. In an embodiment, the pipe may be the third pipe PI3, for example. The flow controller 240 may control the flow rate of the ink IK so that a uniform amount of ink IK is supplied to each of the plurality of head packs 310.

In an embodiment, the flow meter 250 may be connected to the first recovery flow path RF1 between at least one of the plurality of pipes PP and the ink ejection module 300. In an embodiment, the pipe may be the second pipe PI2, for example. The flow meter 250 may measure the flow rate of ink IK flowing from each of the plurality of head packs 310.

In an embodiment, the ink delivery module 200 may further include a thermometer 260 and a temperature controller 270.

The thermometer 260 may be disposed in the body BO. In an embodiment, the thermometer 260 may be disposed in a space between the second pipe PI2 and the third pipe PI3, for example. However, the disclosure is not limited thereto.

The thermometer 260 may measure a temperature of the body BO and supply the measured temperature to the temperature controller 270.

The temperature controller 270 may be connected to the first heater HE1 and the second heater HE2. The temperature controller 270 may control the first heater HE1 and/or the second heater HE2 according to the measured temperature. In an embodiment, when a temperature of the first heater HE1 increases, heat may be supplied to the first pipe PI1 and the second pipe PI2, and the flow rate of the ink IK flowing in through the first recovery flow path RF1 may be faster, for example. When a temperature of the second heater HE2 increases, heat may be supplied to the third pipe PI3 and the fourth pipe PI4, and the flow rate of the ink IK flowing out through the first supply flow path SF1 may be faster.

As shown in FIG. 6, the plurality of modules 210 may be supplied in an assemblable form. In an embodiment, the plurality of modules 210 may include a first module 212 to an (n)th module (where the n is a natural number of 2 or more) and a connection block (e.g., a first connection block 280 and a second connection block 290). A detailed description of the connection block will be described later with reference to FIGS. 11 and 12.

The first module 212 may receive the ink IK from the ink storage module 100. The (n)th module may be spaced farthest from the first module 212 in the first direction DR1.

In FIG. 6, the plurality of modules 210 is described as including the first module 212, a second module 214, and a third module 216, however the disclosure is not limited thereto. In an embodiment, the plurality of modules 210 may variably correspond to the number of head packs 310, for example. That is, the plurality of modules 210 may include two or four or more modules.

FIGS. 7 to 14 are views illustrating the ink delivery module assembly included in the ink delivery module of FIG. 6.

Referring to FIGS. 2, 6, and 7, the plurality of modules 210 included in the ink delivery module 200 may include the first to (n)th modules, the first connection block 280, and the second connection block 290. In an embodiment, the plurality of modules 210 may include the first module 212, the second module 214, the third module 216, the first connection block 280, and the second connection block 290, for example.

As described above, the first module 212 may receive ink IK from the ink storage module 100. The third module 216 may be spaced farthest from the first module 212 in the first direction DR1.

In an embodiment, each of the first module 212, the second module 214, and the third module 216 may include the plurality of pipes PP. The plurality of pipes PP may have a structure that penetrates the body BO in the first direction DR1 and are separated from each other in the second direction DR2.

In an embodiment, the plurality of pipes PP may include the first pipe PI1, the second pipe PI2, the third pipe PI3, and the fourth pipe PI4. Each of the first pipe PI1, the second pipe PI2, the third pipe PI3, and the fourth pipe PI4 may penetrate the body BO in the first direction DR1 and may be spaced apart from each other in the second direction DR2.

In an embodiment, each of the first module 212, the second module 214, and the third module 216 may include the flow path portion FP. The flow path portion FP may be disposed between at least one of the plurality of pipes PP and the ink ejection module 300.

The flow path portion FP may include the first supply flow path SF1 and the first recovery flow path RF1 having structures separated from each other. In an embodiment, the second pipe PI2 may be connected to the first recovery flow path RF1, and the third pipe PI3 may be connected to the first supply flow path SF1.

In an embodiment, the first connection block 280 may contact one surface of the third module 216. The first connection block 280 may include a first connection pipe CPI1 and a second connection pipe CPI2.

In an embodiment, the first connection pipe CPI1 may connect the first pipe PI1 and the second pipe PI2. Accordingly, the ink IK flows into the second pipe PI2 through the first recovery flow path RF1, and the first connection pipe CPI1 connected to the second pipe PI2 and the first pipe PI1 may be recovered through the ink storage module 100.

In an embodiment, the second connection pipe CPI2 may connect the third pipe PI3 and the fourth pipe PI4. Accordingly, the ink IK may flow from the ink storage module 100 into the fourth pipe PI4, and the ink may flow to the ink ejection module 300 through the second connection pipe CPI2 connected to the fourth pipe PI4 and the third pipe PI3.

More specifically, in an embodiment, the first pipe PI1 of the first module 212 may include a first end EP1 and a second end EP2. The second end EP2 may be spaced apart from the first end EP1 in the first direction DR1. The first end EP1 may be connected to the ink storage module 100, and the second end EP2 may be connected to the first pipe PI1 of the second module 214.

In an embodiment, the first pipe PI1 of the (n)th module may include a third end EP3 and a fourth end EP4. In an embodiment, the first pipe PI1 of the third module 216 may include the third end EP3 and the fourth end EP4, for example. The fourth end EP4 may be spaced apart from the third end EP3 in the first direction DR1. The third end EP3 may be connected to the first pipe PI1 of the (n−1)th module. In an embodiment, the third end EP3 may be connected to the first pipe PI1 of the second module 214, for example. The fourth end EP4 may be connected to the first connection pipe CPI1.

In an embodiment, the fourth pipe PI4 of the first module 212 may include a fifth end EP5 and a sixth end EP6. The sixth end EP6 may be spaced apart from the fifth end EP5 in the first direction DR1. The fifth end EP5 may be connected to the ink storage module 100, and the sixth end EP6 may be connected to the fourth pipe PI4 of the second module 214.

In an embodiment, the fourth pipe PI4 of the (n)th module may include a seventh end EP7 and an eighth end EP8. In an embodiment, the fourth pipe PI4 of the third module 216 may include the seventh end EP7 and the eighth end EP8, for example. The eighth end EP8 may be spaced apart from the seventh end EP7 in the first direction DR1. The seventh end EP7 may be connected to the fourth pipe PI4 of the (n−1)th module. In an embodiment, the seventh end EP7 may be connected to the fourth pipe PI4 of the second module 214, for example. The eighth end EP8 may be connected to the second connection pipe CPI2.

In an embodiment, each of the first module 212, the second module 214, and the third module 216 may include the flow controller 240 connected to the supply flow path between at least one of the plurality of pipes PP and the ink ejection module 300. In an embodiment, the flow controller 240 may be connected to each of the first supply flow path SF1, a second supply flow path SF2, and a third supply flow path SF3, for example. Accordingly, the flow controller 240 may control the flow rate of the ink IK so that the uniform amount of ink IK flows in each of the first supply flow path SF1, the second supply flow path SF2, and the third supply flow path SF3.

In an embodiment, each of the first module 212, the second module 214, and the third module 216 may include the flow meter 250 connected to the recovery flow path between at least one of the plurality of pipes PP and the ink ejection module 300. In an embodiment, the flow meter 250 may be connected to each of the first recovery flow path RF1, a second recovery flow path RF2, and a third recovery flow path RF3, for example. Accordingly, the flow meter 250 may measure the flow rate of the ink IK flowing into the first recovery flow path RF1, the second recovery flow path RF2, and the third recovery flow path RF3 from each of the plurality of head packs 310.

Referring to FIGS. 7 and 8, the plurality of modules 210 may include the first module 212 to the (n)th module. Each of the first module 212 to the (n)th module may have substantially a same structure. Therefore, the following description will focus on the second module 214.

In an embodiment, a first surface F1 of the body BO of the first module 212 may contact the second connection block 290, and a second surface F2 may contact the second module 214. The first surface F1 of the body BO of the second module 214 may contact the first module 212, and the second surface F2 may contact the third module 216. The first surface F1 of the body BO of the third module 216 may contact the second module 214, and the second surface F2 may contact the first connection block 280.

The body BO of the second module 214 may include the first surface F1, the second surface F2, a third surface F3, and a fourth surface F4. In an embodiment, the first surface F1 and the second surface F2 may face each other in the first direction DR1, for example. The third surface F3 and the fourth surface F4 may face each other in a direction DR3 (hereinafter also referred to as “protrusion direction”) that crosses the first direction DR1 and the second direction DR2.

In an embodiment, a recovery valve REV may be disposed in the second pipe PI2, and a supply valve SUV may be disposed in the third pipe PI3. In an embodiment, the recovery valve REV may be disposed between the body BO and the first recovery flow path RF1, for example. The supply valve SUV may be disposed between the body BO and the first supply flow path SF1. As shown of FIG. 8, the supply valve SUV and the recovery valve REV may be formed to protrude in the protruding direction (and/or in a direction opposite to the protruding direction).

In an embodiment, the first supply flow path SF1 and the first recovery flow path RF1 may be disposed before and after the body BO, respectively, for example. In an embodiment, the first supply flow path SF1 may include a first sub-supply pipe SSF1 and a second sub-supply pipe SSF2, for example. The first recovery flow path RF1 may include a first sub-recovery pipe SRF1 and a second sub-recovery pipe SRF2.

In an embodiment, a pressure compensation block PCB may be further disposed on a bottom surface of the plurality of modules (e.g., the second module 214).

As described above, the plurality of modules may be added or removed in the first direction DR1. As the plurality of modules is added, a step may occur in the second direction DR2. The pressure compensation block PCB may compensate for the step.

Referring to FIGS. 8, 9, and 10, in an embodiment, an alignment pin AP may be disposed on the first surface F1 of the second module 214, and an alignment hole AH may be defined in the second surface F2.

In an embodiment, the alignment pin AP may protrude from the first surface F1. The alignment hole AH may be defined at a position corresponding to the alignment pin AP in the second surface F2.

In an embodiment, the alignment hole AH may have a degree of freedom in the second direction DR2. As described above, the plurality of modules may be added or removed in the first direction DR1. As the plurality of modules is added, the step may occur in the second direction DR2.

When a size of the alignment hole AH is substantially a same as a size of the alignment pin AP, the alignment pin AP might not be accommodated in the alignment hole AH as the step is formed. As the alignment hole AH is defined to have the degree of freedom in the second direction DR2, the alignment pin AP may be stably accommodated in the alignment hole AH even when the step is formed.

In an embodiment, a sealing member SM may be further disposed on the second surface F2 to surround each of the plurality of pipes PP. In an embodiment, the sealing member SM may be further disposed to surround each of the first pipe PI1, the second pipe PI2, the third pipe PI3, and the fourth pipe PI4, for example.

As the sealing member SM is disposed, leakage at connection portions of each of the first pipe PI1, the second pipe PI2, the third pipe PI3, and the fourth pipe PI4 (e.g., the first end EP1, the second end EP2, the third end EP3, the fourth end EP4, the fifth end EP5, the sixth end EP6, the seventh end EP7, and/or the eighth end EP8 of FIG. 7) may be prevented.

In an embodiment, a fastening groove CH may be defined in the body BO, for example. Accordingly, the body BO may be connected to each other in the first direction DR1, for example. In an embodiment, the body BO may be fastened with bolts and nuts, for example. However, the disclosure is not limited thereto. The body BO may be connected to each other in various ways.

Referring to FIGS. 11, 12, and 13, the plurality of modules 210 may be supplied in the assemblable form. In an embodiment, the plurality of modules 210 may include the first module 212 to (n)th module 21n, the first connection block 280, and the second connection block 290. The n may be a natural number of 2 or more.

In an embodiment, the first surface F1 of the first module 212 may contact the second connection block 290, and the second surface F2 may contact the second module 214. The first surface F1 of the body BO of the second module 214 may contact the first module 212, and the second surface F2 may contact the third module 216. The first surface F1 of the body BO of the (n)th module 21n may contact the (n−1)th module, and the second surface F2 may contact the first connection block 280.

As shown in FIGS. 3, 7, and 12, the second connection block 290 may be connected to the ink ejection module 300. To this end, a first line LI1 and a second line LI2 may be disposed between the second connection block 290 and the ink ejection module 300. In an embodiment, the first line LI1 may constitute the fourth path P4 through which the ink is recovered from the ink ejection module 300, and the second line LI2 may constitute the fourth path P4 through which the ink is supplied from the ink ejection module 300, for example.

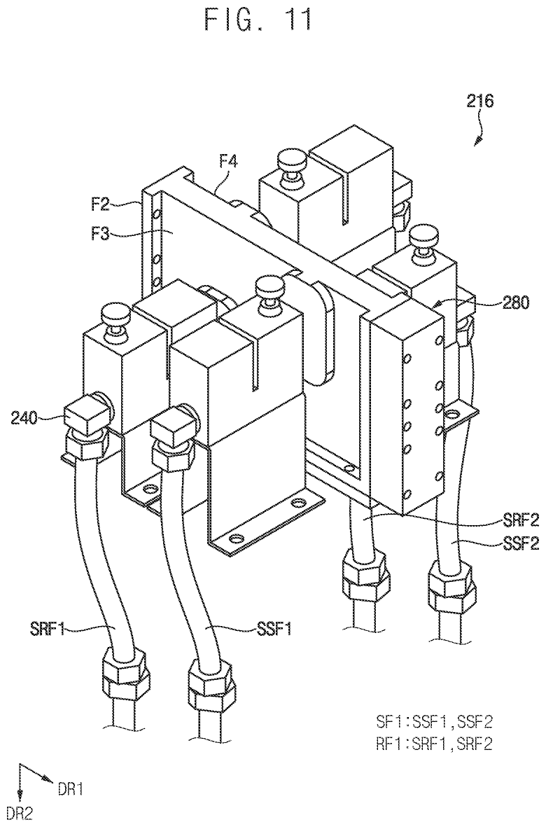

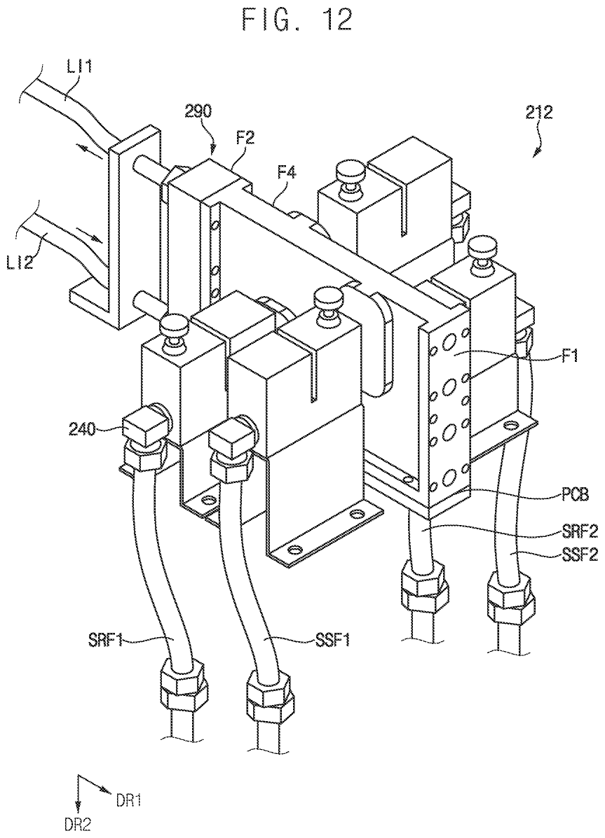

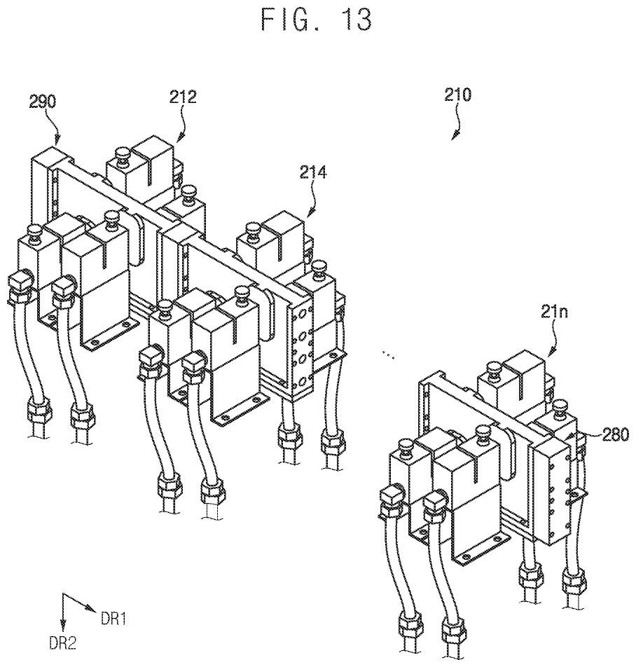

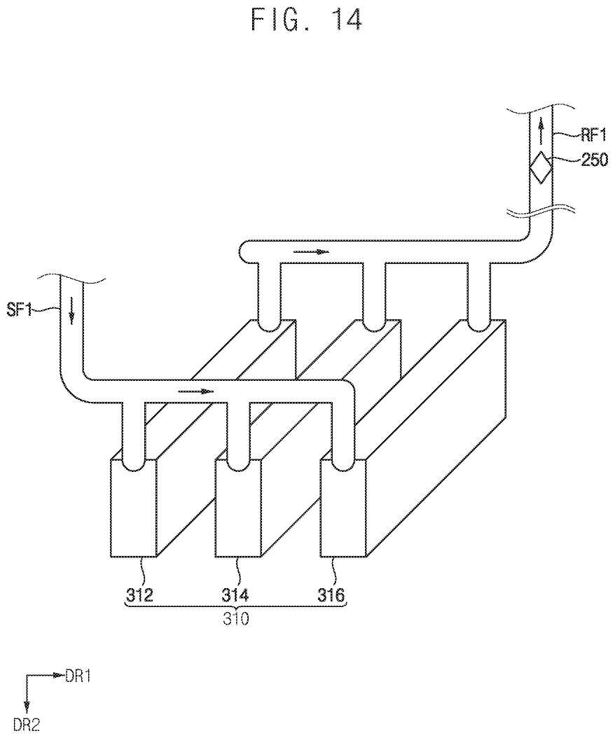

Referring to FIG. 14, the first supply flow path SF1 may have a structure branched into the plurality of head packs 310. The first recovery flow path RF1 may have a structure integrated from the plurality of head packs 310. In FIG. 14, one of the plurality of head packs 310 is shown as including the first head 312, the second head 314, and the third head 316, but the disclosure is not limited thereto. In an embodiment, the number of branches of the first supply flow path SF1 and the first recovery flow path RF1 may vary depending on the number of heads included in the plurality of head packs 310, for example.

As shown in FIGS. 7 and 14, the flow controller 240 may be disposed in the first supply flow path SF1, and the flow meter 250 may be disposed in the first recovery flow path RF1.

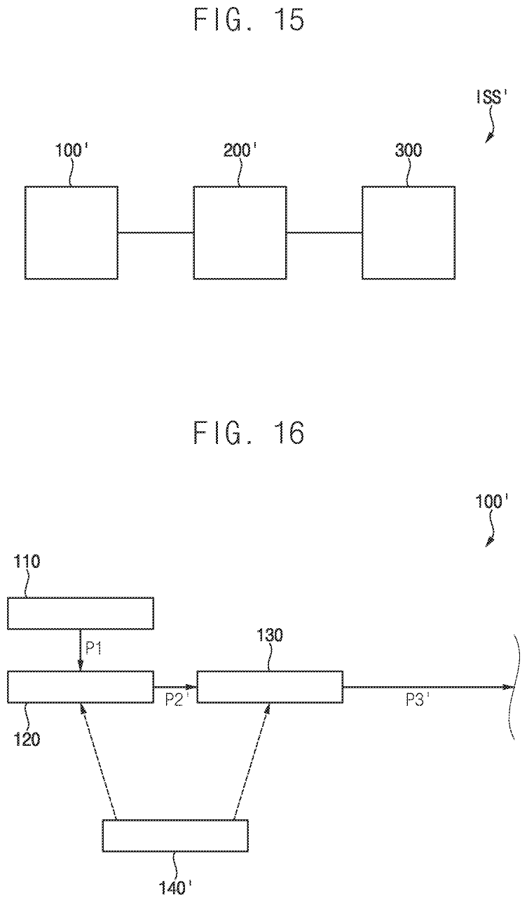

FIG. 15 is a block view illustrating an embodiment of the ink supply system included in the inkjet printer of FIG. 1.

In an embodiment, an ink supply system ISS' of FIG. 15 has an ink storage module 100′ of a non-circulating type and an ink delivery module 200′ includes only a supply flow path may be different, for example. Therefore, hereinafter, descriptions overlapping with the ink supply system ISS described above with reference to FIGS. 2 to 14 will be omitted or simplified.

Referring to FIG. 15, the ink supply system ISS' may include the ink storage module 100′, the ink delivery module 200′, and the ink ejection module 300.

In an embodiment, the ink storage module 100′ may temporarily store the ink. The ink delivery module 200′ may receive the ink from the ink storage module 100′ and deliver the ink to the ink ejection module 300. The ink ejection module 300 may eject the ink.

A detailed description of the configuration of each of the ink storage module 100′ and the ink delivery module 200′ will be described later with reference to FIG. 16 and below.

FIG. 16 is a block view illustrating the ink storage module included in the ink supply system of FIG. 15.

Referring to FIGS. 15 and 16, in an embodiment, the ink storage module 100′ may include the ink tank 110, the first reservoir 120, the second reservoir 130, and a pressure control module 140′.

The pressure control module 140′ may control the internal pressure of the ink tank 110. The ink tank 110 may supply the predetermined amount of the ink to the first reservoir 120 based on the pressure provided by the pressure control module 140′.

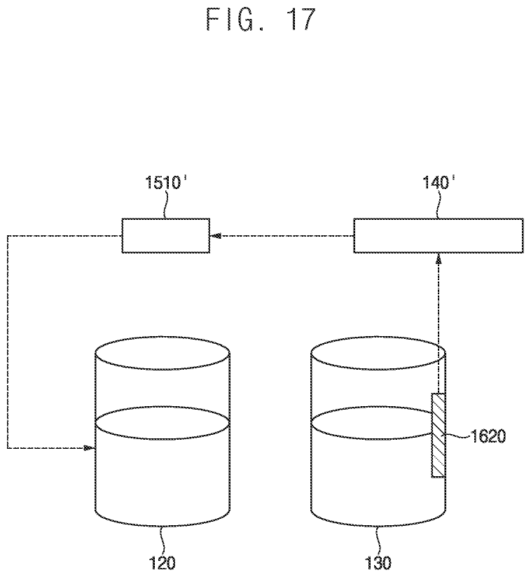

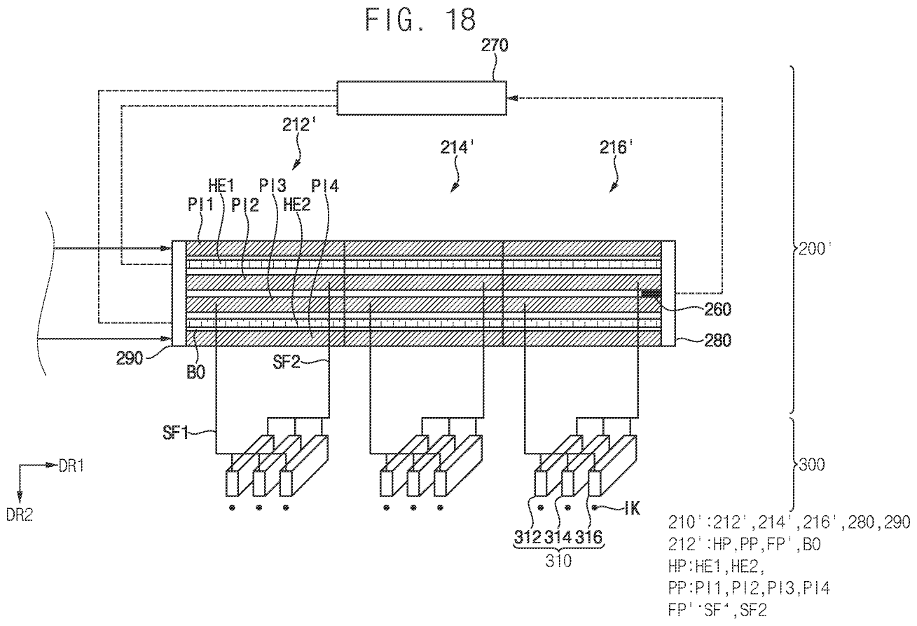

A detailed description of the pressure control module 140′ will be described later with reference to FIG. 17.

In an embodiment, the ink may flow in the first path P1, a second path P2′, and a third path P3′. In an embodiment, the first path P1 may be the path supplying the ink from the ink tank 110 to the first reservoir 120, for example. The second path P2′ may be a path supplied from the first reservoir 120 to the second reservoir 130. The third path P3′ may be a path supplied from the second reservoir 130 to the ink delivery module 200′.

The non-circulating ink storage module 100′ may supply a relatively large amount of the ink to the ink delivery module 200′.

FIG. 17 is a view illustrating the pressure control module included in the ink storage module of FIG. 16.

Referring to FIGS. 16 and 17, the ink storage module 100′ may include the first reservoir 120, the second reservoir 130, the pressure control module 140′, a pump 1510′, and a water level gauge 1620 may be included.

The pressure control module 140′ may control the pressure of the first reservoir 120, the pressure of the second reservoir 130, and a pressure of the pump 1510′.

The pressure control module 140′ may control the pressure of the first reservoir 120. However, the disclosure is not limited thereto. In an embodiment, the pressure control module 140′ may control the pressure of the first reservoir 120 and the pressure of the second reservoir 130, for example.

The water level gauge 1620 may measure the water level of the ink stored in the second reservoir 130.

The water level of the second reservoir 130 measured by the water level gauge 1620 may be transmitted to the pressure control module 140′. The pressure control module 140′ may flow the ink from the first reservoir 120 to the second reservoir 130 using the pump 1510′.

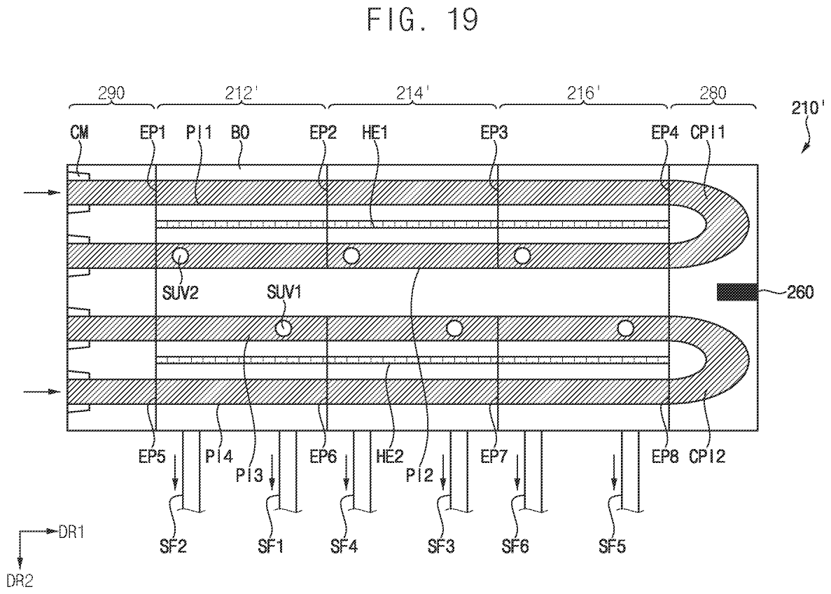

FIG. 18 is a view illustrating the ink delivery module and the ink ejection module included in the ink supply system of FIG. 15.

Referring to FIGS. 15 and 18, in an embodiment, the ink delivery module 200′ may include a plurality of modules 210′. The plurality of modules 210′ may receive the ink IK from the ink storage module 100′ and deliver the ink IK to the ink ejection module 300.

In an embodiment, the ink ejection module 300 may include the plurality of head packs 310. Each of the plurality of head packs 310 may include the plurality of heads that eject the ink IK. In an embodiment, one of the plurality of head packs 310 may include the first head 312, the second head 314, and the third head 316, for example. Each of the first head 312, the second head 314, and the third head 316 may eject the ink IK.

In an embodiment, the plurality of modules 210′ may receive the ink IK from the ink storage module 100′ and deliver the ink IK to each of the plurality of head packs 310.

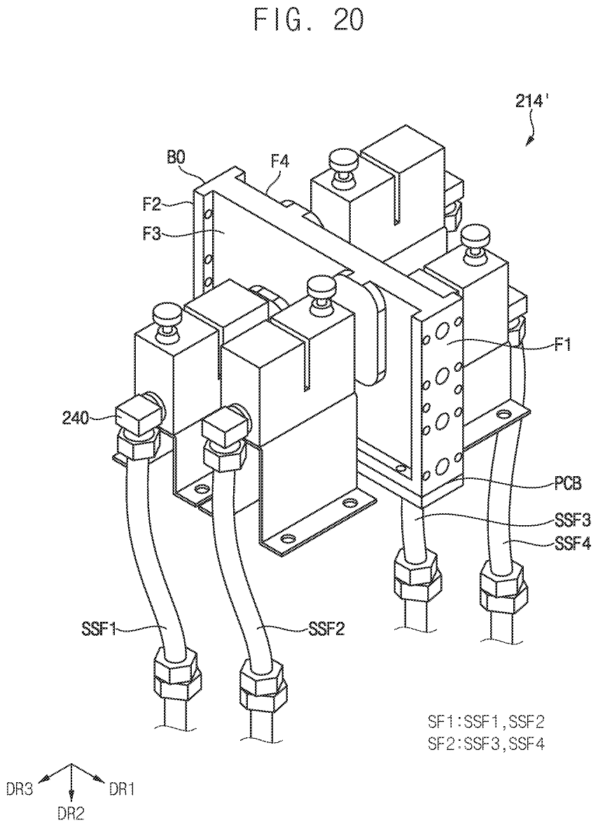

In an embodiment, each of the plurality of modules 210′ may include the body BO, the plurality of pipes PP, a flow path portion FP′, the heating portion HP, and the flow controller (e.g., a flow controller 240 of FIG. 20).

In an embodiment, the body BO may have a structure that may be interconnectable in the first direction DR1. Accordingly, the plurality of modules 210′ may be added or removed depending on the number of head packs 310.

In an embodiment, the plurality of pipes PP may include the first pipe PI1, the second pipe PI2, the third pipe PI3, and the fourth pipe PI4. Each of the first pipe PI1, the second pipe PI2, the third pipe PI3, and the fourth pipe PI4 may penetrate the body BO in the first direction DR1 and may be spaced apart from each other in the second direction DR2.

In an embodiment, the flow path portion FP′ may be disposed between at least one of the plurality of pipes PP and the ink ejection module 300. The flow path portion FP′ may include the first supply flow path SF1 and the second supply flow path SF2 having structures separated from each other.

In an embodiment, the second pipe PI2 may be connected to the second supply flow path SF2, and the third pipe PI3 may be connected to the first supply flow path SF1.

A detailed description of connection piping system between the plurality of pipes PP and the flow path portion FP′ will be described later with reference to FIG. 19.

In an embodiment, the heating portion HP may include the first heater HE1 and the second heater HE2. The first heater HE may penetrate the body BO and be disposed between the first pipe PI1 and the second pipe PI2. The second heater HE2 may penetrate the body BO and be disposed between the third pipe PI3 and the fourth pipe PI4.

In an embodiment, the flow controller 240 may be connected to the first supply flow path SF1 between at least one of the plurality of pipes PP and the ink ejection module 300. In an embodiment, the pipe may be the third pipe PI3. In addition, the flow controller 240 may be connected to the second supply flow path SF2 between at least one of the plurality of pipes PP and the ink ejection module 300, for example. In an embodiment, the pipe may be the second pipe PI2, for example. The flow controller 240 may control the flow rate of the ink IK so that the uniform amount of ink IK is supplied to each of the plurality of head packs 310.

In an embodiment, the ink delivery module 200′ may further include the thermometer 260 and the temperature controller 270.

The thermometer 260 may be disposed in the body BO. In an embodiment, the thermometer 260 may be disposed in the space between the second pipe PI2 and the third pipe PI3, for example. However, the disclosure is not limited thereto.

The thermometer 260 may measure the temperature of the body BO and supply the measured temperature to the temperature controller 270.

The temperature controller 270 may be connected to the first heater HE1 and the second heater HE2. The temperature controller 270 may control the first heater HE1 and/or the second heater HE2 according to the measured temperature. In an embodiment, when the temperature of the first heater HE1 increases, heat may be supplied to the first pipe PI1 and the second pipe PI2, and flow rate of the ink IK flowing out through the second supply flow path SF2 may be faster, for example. When the temperature of the second heater HE2 increases, heat may be supplied to the third pipe PI3 and the fourth pipe PI4, and flow rate of the ink IK flowing out through the first supply flow path SF1 may be faster.

As shown in FIG. 18, the plurality of modules 210′ may be supplied in the assemblable form. In an embodiment, the plurality of modules 210′ include a first module 212′ to the (n)th (where the n is a natural number of 2 or more) module and a connection block (e.g., the first connection block 280 and the second connection block 290). A detailed description of the connection block will be described later with reference to FIG. 19 and below.

The first module 212′ may receive the ink IK from the ink storage module 100′. The (n)th module may be spaced farthest from the first module 212′ in the first direction DR1.

In FIG. 18, the plurality of modules 210′ is described as including the first module 212′, a second module 214′, and a third module 216′, but the disclosure is not limited thereto. In an embodiment, the plurality of modules 210′ may variably correspond to the number of head packs 310. That is, the plurality of modules 210′ may include two or more modules, for example.

FIGS. 19 to 22 are views illustrating the ink delivery module assembly included in the ink delivery module of FIG. 18.

Referring to FIGS. 16, 18, and 19, the plurality of modules 210′ included in the ink delivery module 200′ may include the first to (n)th modules, the first connection block 280, and the second connection block 290. In an embodiment, the plurality of modules 210′ may include the first module 212′, the second module 214′, the third module 216′, the first connection block 280, and the second connection block 290, for example.

As described above, the first module 212′ may receive the ink IK from the ink storage module 100′. The third module 216′ may be spaced farthest from the first module 212′ in the first direction DR1.

In an embodiment, each of the first module 212′, the second module 214′, and the third module 216′ may include the plurality of pipes PP.

In an embodiment, the plurality of pipes PP may include the first pipe PI1, the second pipe PI2, the third pipe PI3, and the fourth pipe PI4. Each of the first pipe PI1, the second pipe PI2, the third pipe PI3, and the fourth pipe PI4 may penetrate the body BO in the first direction DR1 and may be spaced apart from each other in the second direction DR2.

In an embodiment, each of the first module 212′, the second module 214′, and the third module 216′ may include the flow path portion FP′. The flow path portion FP′ may be disposed between at least one of the plurality of pipes PP and the ink ejection module 300.

The flow path portion FP′ may include the first supply flow path SF1 and the second supply flow path SF2 having structures separated from each other. In an embodiment, the second pipe PI2 may be connected to the second supply flow path SF2, and the third pipe PI3 may be connected to the first supply flow path SF1.

In an embodiment, the first connection block 280 may contact one surface of the third module 216′. The first connection block 280 may include the first connection pipe CPI and the second connection pipe CPI2.

In an embodiment, the first connection pipe CPI1 may connect the first pipe PI1 and the second pipe PI2. Accordingly, the ink IK may flow from the ink storage module 100′ into the first pipe PI1, and the ink IK may be supplied to the ink ejection module 300 through the first connection pipe CPI1 connected to the first pipe PI1 and the second pipe PI2.

In an embodiment, the second connection pipe CPI2 may connect the third pipe PI3 and the fourth pipe PI4. Accordingly, the ink IK may flow from the ink storage module 100′ into the fourth pipe PI4, and the ink may be supplied to the ink ejection module 300 through the second connection pipe CPI2 connected to the fourth pipe PI4 and the third pipe PI3.

More specifically, in an embodiment, the first pipe PI1 of the first module 212′ may include the first end EP1 and the second end EP2. The second end EP2 may be spaced apart from the first end EP1 in the first direction DR1. The first end EP1 may be connected to the ink storage module 100′, and the second end EP2 may be connected to the first pipe PI1 of the second module 214′.

In an embodiment, the first pipe PI1 of the (n)th module may include the third end EP3 and the fourth end EP4. In an embodiment, the first pipe PI1 of the third module 216′ may include the third end EP3 and the fourth end EP4. The fourth end EP4 may be spaced apart from the third end EP3 in the first direction DR1, for example. The third end EP3 may be connected to the first pipe PI1 of the (n−1)th module. In an embodiment, the third end EP3 may be connected to the first pipe PI1 of the second module 214′. The fourth end EP4 may be connected to the first connection pipe CPI1, for example.

In an embodiment, the fourth pipe PI4 of the first module 212′ may include the fifth end EP5 and the sixth end EP6. The sixth end EP6 may be spaced apart from the fifth end EP5 in the first direction DR1. The fifth end EP5 may be connected to the ink storage module 100′, and the sixth end EP6 may be connected to the fourth pipe PI4 of the second module 214′.

In an embodiment, the fourth pipe PI4 of the (n)th module may include the seventh end EP7 and the eighth end EP8. In an embodiment, the fourth pipe PI4 of the third module 216 may include the seventh end EP7 and the eighth end EP8, for example. The eighth end EP8 may be spaced apart from the seventh end EP7 in the first direction DR1. The seventh end EP7 may be connected to the fourth pipe PI4 of the (n−1)th module. In an embodiment, the seventh end EP7 may be connected to the fourth pipe PI4 of the second module 214′, for example. The eighth end EP8 may be connected to the second connection pipe CPI2.

In an embodiment, each of the first module 212′, the second module 214′, and the third module 216′ may include the flow controller (e.g., the flow controller 240 of FIG. 20) connected to the supply flow path between at least one of the plurality of pipes PP and the ink ejection module 300. In an embodiment, the flow controller may be connected to the first supply flow path SF1, the second supply flow path SF2, the third supply flow path SF3, a fourth supply flow path SF4, a fifth supply flow path SF5, and a sixth supply flow path SF6, for example. Accordingly, the flow controller 240 may control the flow rate of the ink IK so that the uniform amount of ink IK is supplied to of each of the first supply flow path SF1, the second supply flow path SF2, the third supply flow path SF3, the fourth supply flow path SF4, the fifth supply flow path SF5, and the sixth supply flow path SF6.

Referring to FIGS. 19 and 20, the plurality of modules 210′ may include the first module 212′ to (n)th module. Each of the first module 212′ to the (n)th module may have substantially the same structure. Therefore, the following description will focus on the second module 214′.

In an embodiment, the first surface F1 of the body BO of the first module 212′ may contact the second connection block 290, and the second surface F2 may contact the second module 214′. The first surface F1 of the body BO of the second module 214′ may contact the first module 212′, and the second surface F2 may contact the third module 216′. The first surface F1 of the body BO of the third module 216′ may contact the second module 214′, and the second surface F2 may contact the first connection block 280.

The body BO of the second module 214′ may include the first surface F1, the second surface F2, the third surface F3, and the fourth surface F4. In an embodiment, the first surface F1 and the second surface F2 may face each other in the first direction DR1, for example. The third surface F3 and the fourth surface F4 may face each other in a direction DR3 that intersects the first direction DR1 and the second direction DR2.

In an embodiment, a second supply valve SUV2 may be disposed in the second pipe PI2, and a first supply valve SUV1 may be disposed in the third pipe PI3. In an embodiment, the first supply valve SUV1 may be disposed between the body BO and the first supply flow path SF1, between the body BO and the third supply flow path SF3, and between the body BO and a fifth supply flow path SF5, for example. The second supply valve SUV2 may be disposed between the body BO and the second supply flow path SF2, between the body and the fourth supply flow path SF4, and between the body BO and the sixth supply flow path SF6. As shown of FIG. 19, the first supply valve SUV1 and the second supply valve SUV2 may be formed to protrude in the protruding direction (and/or in the direction opposite to the protruding direction).

In an embodiment, each of the first supply flow path SF1 and the second supply flow path SF2 may be disposed before and after the body BO, respectively, for example. In an embodiment, the first supply flow path SF1 may include the first sub-supply pipe SSF1 and the second sub-supply pipe SSF2, for example. The second supply flow path SF2 may include a third sub-supply pipe SSF3 and a fourth sub-supply pipe SSF4.

In an embodiment, the pressure compensation block PCB may be further disposed on the bottom surface of the plurality of modules (e.g., the second module 214′).

As described above, the plurality of modules may be added or removed in the first direction DR1. As the plurality of modules is added, the step may occur in the second direction DR2. The pressure compensation block PCB may compensate for the step.

Similar to what was described above with reference to FIGS. 8, 9, and 10, in an embodiment, the align pin AP may be disposed on the first surface F1 of the second module 214′, and the alignment holes AH may be defined in the second surface F2.

In an embodiment, the alignment pin AP may protrude from the first surface F1. The alignment hole AH may be defined at the position corresponding to the alignment pin AP in the second surface F2.

In an embodiment, the alignment hole AH may have the degree of freedom in the second direction DR2. As described above, the plurality of modules may be added or removed in the first direction DR1. As the plurality of modules is added, the step may occur in the second direction DR2.

When the size of the alignment hole AH is substantially the same as the size of the alignment pin AP, the alignment pin AP might not be accommodated in the alignment hole AH as the step is formed. As the alignment hole AH is defined to have the degree of freedom in the second direction DR2, the alignment pin AP may be stably accommodated in the alignment hole AH even when the step is formed.

In an embodiment, the sealing member SM may be further disposed on the second surface F2 to surround each of the plurality of pipes PP. In an embodiment, the sealing member SM may include the sealing member SM to surround each of the first pipe PI1, the second pipe PI2, the third pipe PI3, and the fourth pipe PI4, for example.

As the sealing member SM is disposed, the leakage at the connection portions of each of the first pipe PI1, the second pipe PI2, the third pipe PI3, and the fourth pipe PI4 (e.g., the first end EP1, the second end EP2, the third end EP3, the fourth end EP4, the fifth end EP5, the sixth end EP6, the seventh end EP7, and/or the eighth end EP8 of FIG. 7) may be prevented.

In an embodiment, the fastening groove CH may be defined in the body BO, for example. Accordingly, the body BO may be connected to each other in the first direction DR1. In an embodiment, the body BO may be fastened with the bolts and the nuts, for example. However, the disclosure is not limited thereto. The body BO may be connected to each other in various ways.

Similar to what was described above with reference to FIGS. 11, 12, and 13, the plurality of modules 210′ may be supplied in the assemblable form. In an embodiment, the plurality of modules 210′ may include the first module 212′ to the (n)th module, the first connection block 280, and the second connection block 290. The n may be a natural number of 2 or more.

In an embodiment, the first surface F1 of the first module 212′ may contact second connection block 290, and the second surface F2 may contact the second module 214′. The first surface F1 of the body BO of the second module 214′ may contact the first module 212′, and the second surface F2 may contact the third module 216′. The first surface F1 of the body BO of the (n)th module may contact the (n−1)th module, and the second surface F2 may contact the first connection block 280.

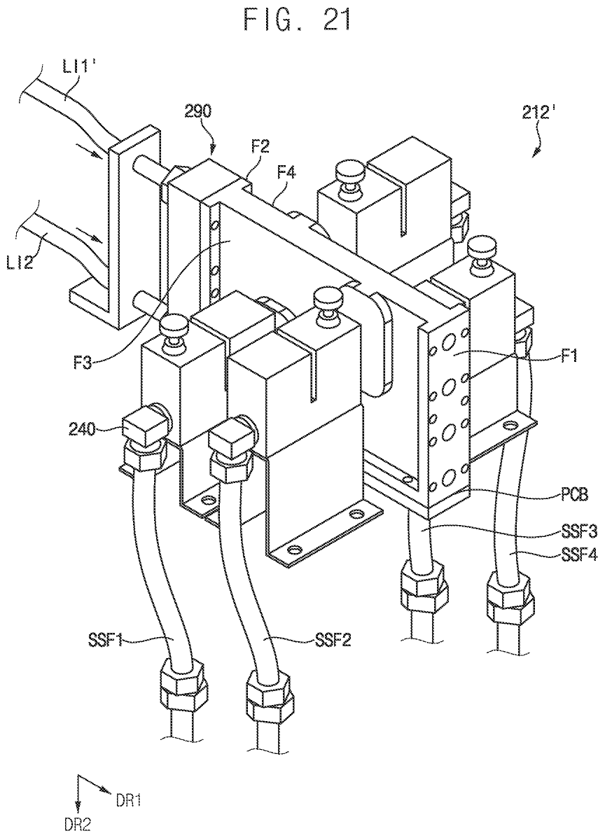

As shown in FIG. 21, the second connection block 290 may be connected to the ink ejection module 300. To this end, a first line LI1′ and the second line LI2 may be disposed between the second connection block 290 and the ink ejection module 300. In an embodiment, the first line LI1′ and the second line LI2 may form the third path P3′ through which the ink is supplied from the ink ejection module 300, for example.

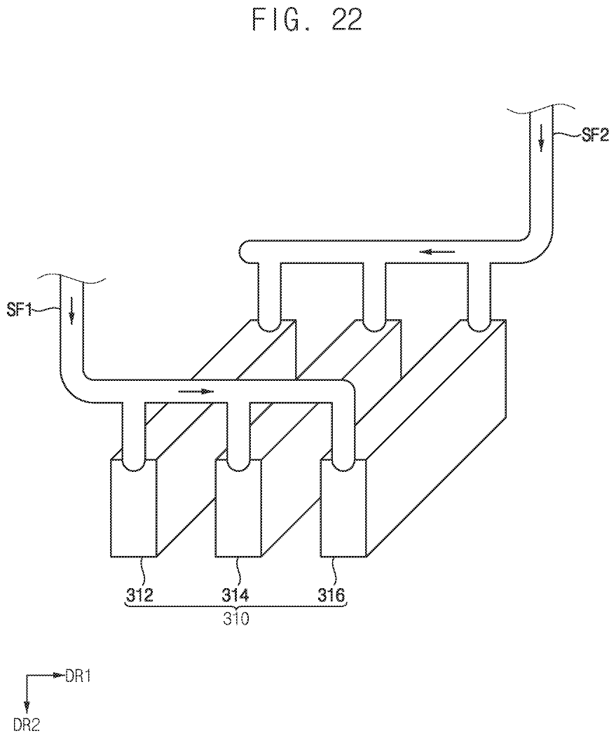

Referring to FIG. 22, each of the first supply flow path SF1 and the second supply flow path SF2 may have a structure branched into the plurality of head packs 310. In FIG. 22, one of the plurality of head packs 310 is shown as including the first head 312, the second head 314, and the third head 316, but the disclosure is not limited thereto. In an embodiment, the number of branches of the first and second supply flow paths SF1 and SF2 may vary depending on the number of heads included in the plurality of head packs 310, for example.

Similar to what was described above with reference to FIGS. 7 and 14, the flow controller 240 may be disposed in the first supply flow path SF1 and the second supply flow path SF2. In addition, when desired, a flow meter may be further disposed.

The inkjet printer in embodiments of the disclosure may be applied to the process of manufacturing display devices included in computers, laptops, mobile phones, smartphones, smart pads, PMPs, PDAs, MP3 players, or the like

Embodiments of the disclosure should not be construed as being limited to the embodiments set forth herein. Rather, these embodiments are provided so that this disclosure will be thorough and complete and will fully convey the concept of the invention to those skilled in the art. While the invention has been particularly shown and described with reference to embodiments thereof, it will be understood by those of ordinary skill in the art that various changes in form and details may be made therein without departing from the spirit or scope of the invention as defined by the following claims.

What is claimed is:

1. An inkjet printer comprising:
an ink ejection module including a plurality of head packs including a plurality of heads which eject an ink;
an ink storage module which stores the ink; and
a plurality of modules which receive the ink from the ink storage module and deliver the ink to each of the plurality of head packs; and
each of the plurality of modules including:
a body having a structure which is interconnectable in a first direction and including a first surface and a second surface which faces the first surface in the first direction;
a plurality of pipes penetrating the body in the first direction and separated from each other in a second direction crossing the first direction;
a first supply flow path and a first recovery flow path disposed between at least one of the plurality of pipes and the ink ejection module and separated from each other; and
a flow controller connected to the first supply flow path between a pipe of the plurality of pipes and the ink ejection module.

2. The inkjet printer of claim 1,
further comprising a connection block, wherein,
the plurality of modules includes a first module which receives the ink from the ink storage module, to an (n)th module, where the n is a natural number of 2 or more, spaced farthest from the first module in the first direction,
the first surface of the body of the (n)th module contacts the (n−1)th module, and
the second surface of the body of the (n)th module contacts the connection block.

3. The inkjet printer of claim 2, wherein,
the plurality of pipes includes a first pipe, a second pipe connected to the first recovery flow path, a third pipe connected to the first supply flow path, and a fourth pipe, and
the connection block includes a first connection pipe connecting the first pipe and the second pipe, and a second connection pipe connecting the third pipe and the fourth pipe.

4. The inkjet printer of claim 3, wherein,
the first pipe of the first module includes a first end, and a second end spaced apart from the first end in the first direction,
the first end is connected to the ink storage module,
the second end is connected to the first pipe of the second module,
the first pipe of the (n)th module includes a third end, and a fourth end spaced apart from the third end in the first direction,
the third end is connected to the first end of the (n−1)th module,
the fourth end is connected to the first connection pipe,
the fourth pipe of the first module includes a fifth end, and a sixth end spaced apart from the fifth end in the first direction,
the fifth end is connected to the ink storage module,
the sixth end is connected to the fourth pipe of the second module,
the fourth pipe of the (n)th module includes a seventh end, and an eighth end spaced apart from the seventh end in the first direction,
the seventh end is connected to the fourth pipe of the (n−1)th module, and
the eighth end is connected to the second connection pipe.

5. The inkjet printer of claim 3, further comprising:
a first heater penetrating the body and disposed between the first pipe and the second pipe; and
a second heater penetrating the body and disposed between the third pipe and the fourth pipe.

6. The inkjet printer of claim 5, further comprising:
a thermometer disposed in the body; and
a temperature controller connected to the first heater and the second heater.

7. The inkjet printer of claim 1, wherein each of the plurality of modules further includes:
a pressure compensation block disposed on a bottom surface of each of the plurality of modules.

8. The inkjet printer of claim 1, wherein each of the plurality of modules further includes an alignment pin protruding from the first surface,
an alignment hole is defined at a position corresponding to the alignment pin in the second surface, and
the alignment hole has a degree of freedom in the second direction.

9. The inkjet printer of claim 1, wherein each of the plurality of modules further includes:
a sealing member which surrounds each of the plurality of pipes on the second surface.

10. The inkjet printer of claim 1, wherein,
the ink storage module includes an ink tank, a first reservoir, and a second reservoir, and
wherein the ink flows in:
a first path supplying from the ink tank to the first reservoir;
a second path circulating between the first reservoir and the second reservoir;
a third path recovering from the second reservoir to the ink tank; and
a fourth path circulating between the plurality of modules and the second reservoir.

11. An inkjet printer comprising:
an ink ejection module including a plurality of head packs including a plurality of heads which eject an ink;
an ink storage module which stores the ink; and
a plurality of modules which receive the ink from the ink storage module and deliver the ink to each of the plurality of head packs, each of the plurality of modules including:
a body having a structure which is interconnectable in a first direction and including a first surface and a second surface which faces the first surface in the first direction;
a plurality of pipes penetrating the body in the first direction and separated from each other in a second direction crossing the first direction;
a first supply flow path and a second supply flow path disposed between at least one of the plurality of pipes and the ink ejection module and separated from each other; and
a flow controller connected to each of the first supply flow path and the second supply flow path between the pipe and the ink ejection module.

12. The inkjet printer of claim 11,
further comprising a connection block, wherein,
the plurality of modules includes a first module which receives the ink from the ink storage module, to an (n)th module (where the n is a natural number of 2 or more) spaced farthest from the first module in the first direction,
the first surface of the body of the (n)th module contacts the (n−1)th module, and
the second surface of the body of the (n)th module contacts the connection block.

13. The inkjet printer of claim 12, wherein,
the plurality of pipes includes a first pipe, a second pipe connected to the second supply flow path, a third pipe connected to the first supply flow path, and a fourth pipe, and
the connection block includes a first connection pipe connecting the first pipe and the second pipe, and a second connection pipe connecting the third pipe and the fourth pipe.

14. The inkjet printer of claim 13, wherein,
the first pipe of the first module includes a first end, and a second end spaced apart from the first end in the first direction,
the first end is connected to the ink storage module,
the second end is connected to the first pipe of the second module,
the first pipe of the (n)th module includes a third end, and a fourth end spaced apart from the third end in the first direction,
the third end is connected to the first end of the (n−1)th module,
the fourth end is connected to the first connection pipe,
the fourth pipe of the first module includes a fifth end, and a sixth end spaced apart from the fifth end in the first direction,
the fifth end is connected to the ink storage module,
the sixth end is connected to the fourth pipe of the second module,
the fourth pipe of the (n)th module includes a seventh end, and an eighth end spaced apart from the seventh end in the first direction,
the seventh end is connected to the fourth pipe of the (n−1)th module, and
the eighth end is connected to the second connection pipe.

15. The inkjet printer of claim 13, further comprising:
a first heater penetrating the body and disposed between the first pipe and the second pipe; and
a second heater penetrating the body and disposed between the third pipe and the fourth pipe.

16. The inkjet printer of claim 15, further comprising:
a thermometer disposed in the body; and
a temperature controller connected to the first heater and the second heater.

17. The inkjet printer of claim 11, wherein each of the plurality of modules further includes:
a pressure compensation block disposed on a bottom surface of each of the plurality of modules.

18. The inkjet printer of claim 11, wherein each of the plurality of modules further includes an alignment pin protruding from the first surface,
an alignment hole is defined at a position corresponding to the alignment pin in the second surface, and
the alignment hole has a degree of freedom in the second direction.

19. The inkjet printer of claim 11, wherein each of the plurality of modules further includes:
a sealing member which surrounds each of the plurality of pipes on the second surface.

20. The inkjet printer of claim 11, wherein,
the ink storage module includes an ink tank, a first reservoir, and a second reservoir, and wherein the ink flows in:
a first path supplying from the ink tank to the first reservoir;
a second path circulating between the first reservoir and the second reservoir;
a third path recovering from the second reservoir to the ink tank; and
a fourth path circulating between the plurality of modules and the second reservoir.
